(19) United States
(12) Patent Application Publication
(10) Pub. No.: US 2025/0206090 A1
(43) Pub. Date: Jun. 26, 2025

(54) VULCANIZATION BONDING INSTEAD OF SEAM

(71) Applicant: HÜBNER GmbH & Co. KG, Kassel (DE)

(72) Inventors: Andreas Wiegrefe, Fulda (DE); Reinhard Hübner, Kassel (DE)

(73) Assignee: HÜBNER GmbH & Co. KG, Kassel (DE)

(21) Appl. No.: 18/988,242

(22) Filed: Dec. 19, 2024

(30) Foreign Application Priority Data
Dec. 21, 2023 (EP) 23219250.0
Nov. 19, 2024 (EP) 24213876.6

(51) Int. Cl. B60D 5/00

(52) U.S. Cl. CPC B60D 5/003; B60D 5/006

(57) ABSTRACT

A bellows, as gangway protection for a transitional bridge between two movably connected wagon bodies of a multi-part vehicle or between two movably connected portions of a passenger bridge or passenger stairs, has a roof and two side walls arranged opposite one another. The two side walls or the roof or a connecting region between one of the two side walls and the roof each have a plurality of folds or corrugations. The plurality of folds or corrugations include at least a first blank and a second blank connected to the first blank made of a flexible sheet material, and the first blank and the second blank are at least partially materially bonded to one another.

### CROSS-REFERENCE TO RELATED APPLICATIONS

This application claims priority to European Patent Applications 23219250.0, filed Dec. 21, 2023, and 24213876.6, filed Nov. 19, 2024, which are hereby incorporated by reference in their entirety.

### FIELD OF THE INVENTION

The present invention relates to a bellows as gangway protection for a transitional bridge between two movably connected wagon bodies of a multi-part vehicle or between two movably connected portions of a passenger bridge or passenger stairs, the bellows having a roof and two side walls arranged opposite one another, wherein at least the two side walls or the roof or a connecting region between one of the two side walls and the roof each have a plurality of folds or corrugations, wherein the plurality of folds or corrugations comprises at least a first blank and a second blank connected to the first blank made of a flexible sheet material.

The present invention also relates to a method for producing a bellows as gangway protection for a transitional bridge between two movably connected wagon bodies of a multi-part vehicle or between two movably connected portions of a passenger bridge or passenger stairs, the bellows having a roof or two side walls arranged opposite one another, wherein the method comprises the following steps:
i) providing a first blank made of a flexible sheet material,
ii) providing a second blank made of a flexible sheet material,
iii) forming at least the two side walls or the roof or a connecting region between one of the two side walls and the roof with the first and second blanks such that at least each of the two side walls or the roof or the connecting region between one of the two side walls and the roof has a plurality of folds or corrugations.

### BACKGROUND OF THE INVENTION

In public transport, such as buses and trains, but also in passenger bridges and passenger stairs, it is common practice to protect the gangway between two wagon bodies or an aircraft and the end of the bridge or stairs for the passengers from weather, drafts and other environmental influences. The bellows required for this purpose enclose the gangway at least in the region of the roof and the side walls arranged opposite one another.

The individual bellows is typically constructed from a flexible sheet material at least in the region of the side walls, in the region of the roof or in a connecting region between one of the two side walls and the roof, so that the bellows can compensate for relative movements between the wagon bodies or the portions.

The bellows known from the prior art are formed by sewing together a plurality of blanks from the flexible sheet material. When sewing, the flexible sheet material is pierced with a needle and a thread is passed through the material. This makes it necessary to subsequently seal the resulting seams. Otherwise, moisture and dirt will get through the holes in the flexible sheet material into the region actually protected by the bellows. The formation of seams is complex and does not always result in a visually perfect appearance of the bellows in the region of the seam.

Mere mentions of adhesive bonds without mentioning details of their realization can be found in the prior art, for example in patent applications EP3210802 A1, EP4186771 A1 or U.S. Pat. No. 6,085,403 A.

### SUMMARY OF THE INVENTION

Therefore, compared to the prior art, it is an object of the present invention to provide a bellows and a method for producing such a bellows, which reduce or avoid at least one of the disadvantages mentioned.

The above-mentioned object is achieved according to the invention by a bellows having the features described herein. For this purpose, in a bellows of the type mentioned above, the first blank and the second blank are at least partially materially bonded to one another. The first blank and the second blank overlap along one of their sides or abut one another, with an adhesive being arranged between the first blank and the second blank. This adhesive can comprise both an at least partially viscous substance and a self-adhesive flat element such as a tape, the latter preferably being formed from or with an elastomer. When referring to the at least partially viscous substance, the term ‘viscous’ will be used sometimes in the following for the sake of simplicity.

The viscous substance used as an adhesive can be available in various degrees of viscosity, from liquid to viscous. This enables precise customization to the specific requirements of the bellows. Viscous adhesives can easily penetrate small gaps and imperfections, ensuring an uniform and strong bond. Adhesives containing elastomers provide additional flexibility and elasticity. This is particularly beneficial when the bellows is subject to movement and stretching, as the adhesive can absorb these movements without tearing or separating.

Self-adhesive tapes, on the other hand, are easy to apply and require no special tools or curing times. This reduces manufacturing costs and speeds up the production process. These tapes can be manufactured in different widths, thicknesses and material combinations to fulfil specific requirements. They provide a uniform adhesive layer that ensures a consistent bond. Both viscous adhesives and self-adhesive tapes provide a strong and durable bond between the blanks. This increases the structural integrity of the bellows. Viscous adhesives and elastomeric tapes are often resistant to extreme temperatures. This makes them ideal for applications where the bellows is exposed to (very) high or low temperatures.

Surprisingly, it has been found that a material bond by gluing between the first blank and the second blank can withstand similarly high transverse strains as a sewn connection between a first blank and a second blank. By eliminating the need to pierce the first blank or the second blank at specific points, as is the case when sewing, the material bond according to the invention means that no additional seam sealing is required. This also improves the appearance of the bellows.

By reducing the number of processing steps when connecting the first and second blanks, an overall reduction in production time, personnel costs, material costs and machine costs can be achieved.

In one embodiment of the invention, the two materially bonded blanks are not additionally positively connected to one another. In a further embodiment, the two blanks are exclusively materially bonded to one another.

In one embodiment of the invention, the first blank and the second blank are non-positively connected to one another by means of a clamping profile in addition to the material bond.

In principle, it is possible to implement the invention in that the material bond between the first blank and the second blank is realized only on one of the two side walls or on both side walls. It is also possible to implement the bellows according to the invention only by a first blank and a second blank of the roof being at least partially materially bonded to one another. Furthermore, it is also possible to implement the bellows according to the present invention in that a first blank and a second blank of a connecting region between one of the two side walls and the roof are at least partially connected to one another in a coherent manner. Such connecting regions between one of the two side walls and the roof can be corners or edges of the bellows.

A fold or a corrugation is a section or a segment of the respective side wall, the roof or a connecting region between one of the two side walls and the roof, which in cross section describes a path from the inside of the bellows toward the outside to the outside and back again or vice versa. Several such sections or segments can form a complete bellows. For the longitudinal extension in the direction of passage of the bellows, several folds or corrugations are arranged one behind the other. For a bellows spanning the passageway, the corrugations or folds can be arranged in alignment with each other and connected to each other, for example the corrugations of a side wall and a roof or a connecting section to the roof.

Corrugations and folds consist of a (longer) longitudinal side and a (shorter) transverse side. A corrugation has an apex at the point where the gradient changes. In addition, the individual neighboring corrugations merge into one another via an inner corrugation edge.

In one embodiment, the two side walls and the roof and optionally also two connecting portions between each side wall and the roof have a plurality of folds or corrugations.

It is possible to materially bond the first blank and the second blank to one another only partially, while another portion has a non-materially bonded connection. In one embodiment of the invention, the first blank and the second blank are completely materially bonded to one another, i.e. all portions of the connection are at least also, but preferably exclusively, materially bonded.

In one embodiment of the invention, the bellows is a folding bellows, wherein the folds are arranged in a zigzag manner in a cross-sectional plane. Each fold of a folding bellows has an approximately V-shaped profile in the cross-sectional plane. In one embodiment of a folding bellows, each fold has two approximately straight blanks.

In one embodiment, a fold comprises exactly two blanks, here referred to as the first blank and the second blank. In one embodiment of the invention, the first blank and the second blank are connected to one another at the apex of the fold. Each fold is also connected to at least one adjacent fold. Both the connection of two blanks at the apex of a fold and the connection of one fold to the adjacent fold can be designed to be materially bonded according to the invention.

In another embodiment of the invention, the bellows is a corrugated bellows, wherein each corrugation extends in an arc shape in a cross-sectional plane. The corrugations of a corrugated bellows have an approximately U-shaped profile in the cross-sectional plane.

In one embodiment, a corrugation is formed by exactly one blank, which either extends curved from the inside to the outside and then back to the inside or vice versa. In one embodiment, the first blank forms a first corrugation and the second blank forms a second corrugation, wherein the first blank and the second blank are materially bonded to one another to connect the first corrugation to the second corrugation.

In one embodiment of the invention, the first blank and the second blank each have a narrow side and a long side. In one embodiment of the invention, the first blank and the second blank are substantially rectangular. In one embodiment, the first blank and the second blank are connected to one another along their long sides.

The narrow, transverse side of a blank used to form the corrugation or a fold of one of the two side walls extends, when the bellows is installed, substantially parallel to the transitional bridge between the wagon bodies or the portions of the passenger bridge or passenger stairs. In the case of a bellows for a transitional bridge between two movably connected wagon bodies, the narrow side of such a blank of the two side walls extends substantially horizontally. In contrast, when the bellows is installed, the long side of a fold or corrugation of one of the side walls extends substantially vertically or perpendicularly to the transitional bridge.

In one embodiment of the invention, the first blank and the second blank overlap along one of their sides, wherein an adhesive is disposed between the first blank and the second blank. In an alternative embodiment, the first blank and the second blank abut one another along one of their sides (i.e., they do not overlap), wherein an adhesive is disposed between the first blank and the second blank.

In one embodiment of the invention, the flexible sheet material comprises a polymer. In one embodiment of the invention, the polymer is an elastomer.

In a further embodiment, the polymer of the flexible sheet material is selected from a group consisting of an ethylene-propylene-diene rubber (EPDM), a silicone rubber, a chlorosulfonated polyethylene (CSM, e.g. Hypalon), a chloroprene rubber (e.g. neoprene) and an ethylene-vinyl acetate copolymer (EVAC or EVA), or a combination thereof.

In one embodiment of the invention, the adhesive is selected from a group consisting of an elastomer adhesive, a silicone rubber, an acrylate adhesive (e.g. a cyanate acrylate adhesive), a polyurethane adhesive, a resin adhesive (e.g. a resorcinol resin), a dispersion adhesive and a polyvinyl acetate adhesive, or a combination thereof.

In one embodiment of the invention, the adhesive comprises an adhesive tape with a silicone rubber.

In one embodiment of the invention, the adhesive tape has a thickness of at least 0.1 mm, preferably of at least 0.3 mm and particularly preferably of at least 0.5 mm. It has been found that the specified minimum thicknesses are necessary to prevent the adhesive bond from breaking under tensile stress, particularly when transverse strains occur. The thickness of the adhesive tape between the first blank and the second blank determines the elasticity of the positive-type connection. In one embodiment of the invention, the adhesive tape has a thickness of at most 3 mm. In one embodiment of the invention, the thickness of the adhesive tape is less than the thickness of the first blank and less than the thickness of the second blank. In one embodiment of the invention, the thickness of the first blank and/or the second blank has a value in a range of 2.5 mm to 3 mm.

In one embodiment of the present invention, the base of the polymer of the flexible sheet material of the first blank and the second blank and a polymer of the adhesive are similar to one another. In one embodiment of the invention, the base of the polymer of the flexible sheet material of the first blank and the second blank and a polymer of the adhesive are identical.

In one embodiment of the invention, the adhesive tape therefore comprises a silicone elastomer as well as the flexible sheet material of the first and second blanks.

In one embodiment, a similarity between the base of the polymer of the flexible sheet material and the polymer of the adhesive is present when both the polymer of the adhesive and the polymer of the blanks each have a broad, preferably similar molecular weight distribution.

In one embodiment, a similarity between the base of the polymer of the flexible sheet material and the polymer of the adhesive is present when both the polymer of the adhesive and the polymer of the flexible sheet material each have a narrow molecular weight distribution.

In one embodiment, the bellows comprises a roof and two side walls arranged opposite one another, wherein at least the two side walls or the roof or a connecting region between one of the two side walls and the roof each have a plurality of folds or corrugations, wherein the plurality of folds or corrugations comprises at least a first blank and a second blank connected to the first blank made of a flexible sheet material, the first blank and the second blank being at least partially materially bonded to one another. An adhesive tape with a silicone rubber and a thickness of at least 0.1 mm is arranged between the first blank and the second blank. The bellows is preferably obtained by a method comprising the following steps: providing the first blank, providing the second blank, applying the unvulcanized adhesive tape to the first blank, applying the second blank to the adhesive tape and vulcanizing the adhesive tape, wherein the vulcanization comprises the steps of pressing the first blank together, pressing the second blank and the adhesive tape together and introducing heat, steam, pressure (for example by means of an autoclave) or electromagnetic radiation into the adhesive tape. The relevant procedure is explained below.

In one embodiment of the invention, the bellows has a base in addition to the roof and the two side walls arranged opposite one another. In one embodiment, this base extends under the transitional bridge between the wagon bodies. In one embodiment of the invention, the base also has a plurality of folds or corrugations made of first and second blanks of the flexible sheet material.

In one embodiment of the invention, one or more corrugations or folds of the bottom, the side walls or the roof of the bellows are formed from only a single first blank and a single second blank.

In one embodiment of the invention, one or more corrugations or folds of the base, the side walls and the roof of the bellows are formed only from a single first blank and a single second blank, so that essentially two U-shaped bellows parts comprising side walls, roof and base are connected by a first blank and a second blank. Here, the two blanks are joined together transversely to the longitudinal axis of the respective corrugation or fold.

According to one embodiment of the invention, the materially bonded connection can therefore be made longitudinally along the course of a corrugation or fold. In one embodiment, however, the invention also comprises the materially bonded connection being produced transversely thereto, for example in order to connect together entire 360-degree circumferential corrugation or folding halves or even bellows halves from several corrugations or folds that have already been connected in a materially bonded or other manner.

This connection of circumferential corrugations or folds through to entire bellows halves can already be used in bellows production. This solution provides a cost-effective and component-saving alternative to the state of the art: The bellows material at the ends of a corrugation or fold is not held by holding frames, but the corrugations or folds are connected to each other with a material bond. Holding frames can optionally be provided, for example, in the end area of the bellows as a mounting frame for mounting the bellows on the end faces of the vehicle parts and as a coupling frame for coupling two bellows halves in the direction of travel. Most holding frames, namely all holding frames between two individual corrugations or folds within a transition bellows, can be omitted. By connecting two halves, sufficient overall rigidity is created to replace the previous holding frames. There are two reasons for the rigidity and internal stability of a U-shaped bellows section: On the one hand, the corrugations or folds brought into shape stabilize one other, which prevents the structure from collapsing. On the other hand, according to one embodiment of the invention, the bellows materials for the side walls, roof or corners, for example, are based on different elastomer-coated textiles. The mechanical properties of the different textiles are designed according to the loads to which they are exposed due to their position in the overall bellows. These different textiles and their mechanical properties can be achieved, for example, by using different weft densities in the textile.

The essential U-shape of the bellows parts is often advantageous but is not a necessity. Instead, the two halves to be connected could also be shaped in sections or completely rounded, curved or with an interruption of the U. According to one embodiment, the two halves of the bellows can also have different radii and different lengths in the direction of passage of the overall bellows.

The inside of the bellows defines the gangway between two articulated vehicles or vehicle parts. The bellows can be circumferential but does not necessarily require to be completely circumferential.

In one embodiment of the invention, the bellows has a mounting frame on one front end for mounting the bellows on a wagon body of the multi-part vehicle or on a portion of the passenger bridge or passenger stairs. In a further embodiment of the invention, the bellows has a coupling frame on one front end, in particular on the front end opposite the flange, for connecting the bellows to a second bellows mounted on another wagon body or on another portion of the passenger bridge or passenger stairs.

The above-mentioned object is additionally also achieved by a transitional system with a bellows in an embodiment as described above, and a transitional bridge. Such a transitional system is supplied to the manufacturers of railway carriages or bus vehicles as a supplied part or system.

In one embodiment, the present invention also relates to a vehicle, in particular a railway carriage or a bus vehicle, with a wagon body, on the front end of which a bellows according to an embodiment as described above is mounted.

Furthermore, in one embodiment, the present invention also relates to a portion of a passenger bridge or passenger stairs, on the front end of which a bellows according to an embodiment as described above is mounted.

In one embodiment of the invention, the bellows is obtainable by a method comprising the following steps:
A) providing the first blank,
B) providing the second blank,
C) applying an adhesive tape with a non-vulcanized elastomer or a viscous substance to the first blank,
D) applying the second blank to the adhesive tape or the viscous substance so that the first blank and the second blank overlap along one of their sides or abut one another, and
E) vulcanizing at least the adhesive tape or the viscous substance and optionally the first blank or the second blank.

It has been shown that providing the adhesive tape between the first blank and the second blank as a non-vulcanized semifinished product and subsequently vulcanizing at least the adhesive tape creates a permanently elastic and highly resilient connection between the first blank and the second blank. The key to this is the vulcanization of the adhesive tape in contact with the first and second blanks.

The above object is also achieved by a method as disclosed herein. For this purpose, the method of the type mentioned above further comprises the following step:
iv) materially bonding the first blank and the second blank by applying a at least partially viscous substance or an adhesive tape, preferably out of or with an elastomer.

In one embodiment of the invention, the material bonding in step iv) comprises the following steps:
applying an adhesive with a non-crosslinked polymer to the first blank,
applying the second blank to the adhesive, and
crosslinking the adhesive.

In a further embodiment, the material bonding in step iv) comprises the following steps:
applying an adhesive tape with a non-vulcanized elastomer to the first blank,
applying the second blank to the adhesive tape, and
vulcanizing the adhesive tape.

In one embodiment of the invention, the flexible sheet material of the first and second blanks is already vulcanized before the adhesive tape is applied.

In one embodiment of the invention, vulcanization is initiated by introducing heat or electromagnetic radiation into the adhesive tape.

In one embodiment of the invention, vulcanization of at least the adhesive tape takes place under pressure.

In one embodiment of the invention, at least one surface of the first blank or one surface of the second blank to which the adhesive tape is applied is at least cleaned, degreased or roughened before being brought into contact with the adhesive tape.

In one embodiment of the invention, the method additionally comprises at least one of the following steps:
v) applying a primer to at least the first blank in a region in which the adhesive tape is applied to the first blank, or to the second blank in a region in which the second blank is applied to the adhesive tape, or
vi) providing the adhesive tape with a primer.

Such a primer serves as a pre-coat or primer to improve the adhesion and/or durability of the adhesive tape to the surface of the first and second blanks.

### BRIEF DESCRIPTION OF THE DRAWINGS

Further advantages, features and possible applications of the present invention will become apparent from the following description of two embodiments and the accompanying figures. In the figures, the same elements are designated with identical reference signs.

FIG. 1 is a schematic view of a multi-part vehicle with a bellows according to the invention;

FIG. 2 is a schematic cross-sectional view through a folding bellows according to the present invention;

FIG. 3 is a schematic cross-sectional view through a corrugated bellows according to the present invention;

FIG. 4 is an enlarged, schematic cross-sectional view of the connection between two blanks in a bellows of FIG. 2 or 3; and

FIG. 5 is a schematic diagram of an alternative connection between two blanks in a bellows of FIG. 2 or 3.

### DETAILED DESCRIPTION OF THE INVENTION

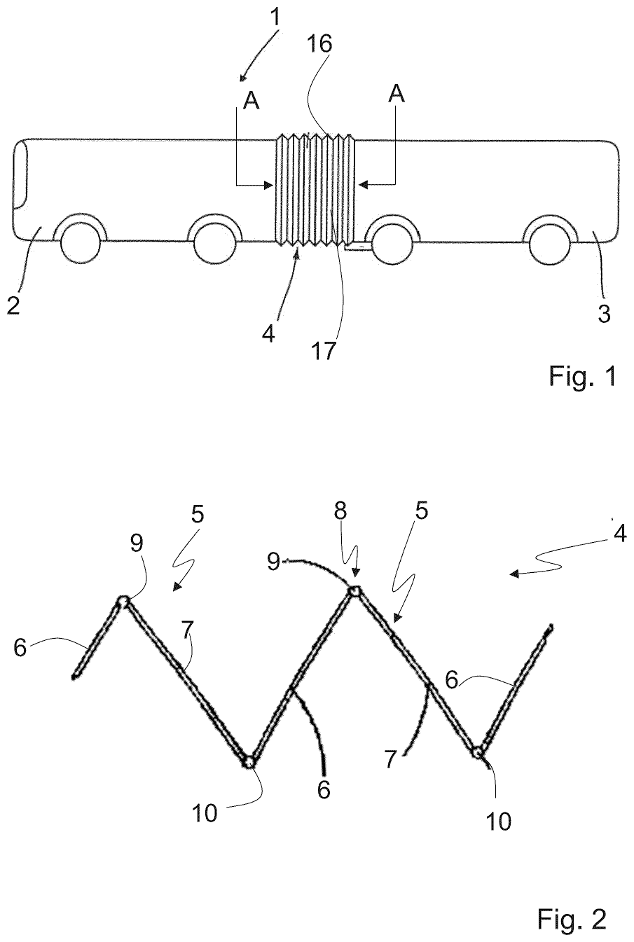

FIG. 1 is a schematic view of a bus 1 as a multi-part vehicle in the sense of the present application. The bus consists of a front car 2 and a rear car 3, which are coupled together. A transitional bridge allows passengers to move from the front car 2 to the rear car 3 and vice versa. In order to protect this transitional bridge from environmental influences, a bellows 4 according to the invention serves as gangway protection for the transitional bridge. In this embodiment, the bellows consists of side walls 17 and a roof 16.

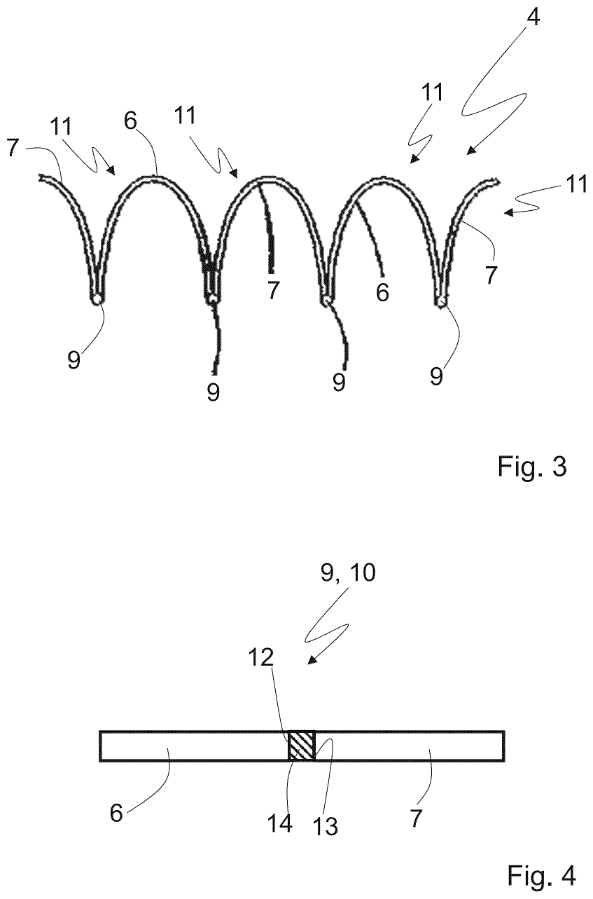

Such bellows 4 are typically designed as folding bellows or as corrugated bellows. FIG. 2 shows a cross section through a side wall of a folding bellows 4 along a section plane A-A from FIG. 1. FIG. 3 shows a cross section through a side wall of a corrugated bellows 4 along a section plane A-A from FIG. 1.

The folds 5 of the folding bellows from FIG. 2 are arranged in a zigzag manner in the section plane A-A from FIG. 1. Each fold 5 has an approximately V-shaped profile in the section plane A-A. In the variant shown, each fold 5 consists of exactly two blanks, namely a first blank 6 and a second blank 7 made of a flexible sheet rubber. The first blank 6 and the second blank 7 are connected to one another at the apex 8 of the fold 5. Each fold 5 is also connected to at least one adjacent fold 5. Both the connection 9 of the respective first and second blanks 6, 7 at the apex 8 and the connection 10 of a fold 5 to the adjacent fold 5 are materially bonded according to the invention. However, embodiments in which only a materially bond of the blanks and not of the folds to one another is realized, or vice versa, are also conceivable in and encompassed by this invention.

In a corrugated bellows as shown in FIG. 3, each corrugation 11 of the section plane A-A is noticeably curved. The corrugations of a corrugated bellows have an approximately U-shaped profile in the section plane A-A.

A corrugation 11 is formed by exactly one blank 6, 7 of a flexible sheet rubber, which either extends curved from the inside outward and then back to the inside or curved inward toward the passenger compartment. In the variant shown here, the first blank 6 forms a first corrugation 11 and the second blank 7 forms a second corrugation 11. The first blank 6 and the second blank 7 are materially bonded to one another in order to connect the first corrugation 11 to the second corrugation 11.

The connections 9, 10 between the first and second blanks 6, 7 are designed as a conventional seam in the folding and corrugated bellows 4 of the prior art. Holes are made in the sheet material of the individual blanks 6, 7 and a technical yarn is passed through them.

In contrast, the connections 9, 10 of the bellows 4 from FIGS. 2 and 3 completely dispense with a positive-type connection and also with a non-positive connection. Instead, they are designed exclusively as a material bond.

FIG. 4 shows how this materially bond between a first and a second blank 6, 7 is formed in the folding bellows 4 from FIG. 2. In this variant, an acrylate adhesive 14 is provided between the front surfaces 12, 13 of the first and second blanks 6, 7.

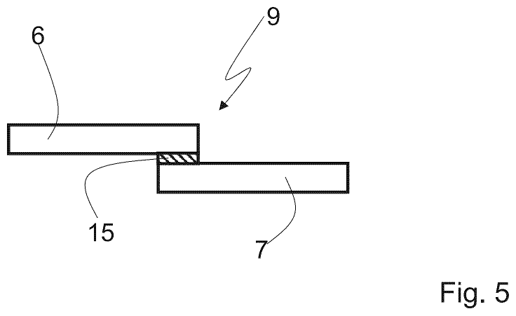

In contrast, FIG. 5 shows how the material bond between a first and a second blank 6, 7 could be formed in the corrugated bellows 4 from FIG. 3. An adhesive tape 15 made of rubber with a thickness of 0.2 mm is arranged between the first blank 6 and the second blank 7. To create the connection 9, the first blank 6 and the second blank 7 were first provided. The not yet vulcanized adhesive tape 15 was applied to the first blank 6. The second blank 7 was then applied to the adhesive tape 15 and finally the adhesive tape 15 was vulcanized under the effect of pressure by introducing heat into the adhesive tape 15.

For the purposes of the original disclosure, it is pointed out that all features, as they are apparent to a person skilled in the art from the present description, the drawings and the claims, even if they have been described specifically only in conjunction with certain further features, can be combined both individually and in any combination with other of the features or groups of features disclosed here, insofar as this has not been expressly excluded or technical circumstances make such combinations impossible or meaningless. The comprehensive explicit representation of all conceivable combinations of features is omitted here only for the sake of brevity and readability of the description.

While the invention has been shown and described in detail in the drawings and the preceding description, this representation and description are merely exemplary and are not intended as a limitation of the scope of protection, as defined by the claims. The invention is not limited to the disclosed embodiments.

Modifications of the disclosed embodiments are apparent to a person skilled in the art from the drawings, the description, and the accompanying claims. In the claims, the word “comprise” does not exclude other elements or steps, and the indefinite article “a” or “an” does not exclude a plurality. The mere fact that certain features are claimed in different claims does not exclude their combination. Reference signs in the claims are not intended to be limiting of the scope of protection.

### REFERENCE SIGNS

1 Bus
2 Front car
3 Rear car
4 Bellows
5 Fold
6 First blank
7 Second blank
8 Apex of the fold
9, 10 Connection
11 Corrugation
12, 13 Front surface
14 Acrylate adhesive
15 Adhesive tape
16 Roof
17 Side wall

1. A bellows as gangway protection for a transitional bridge between two movably connected wagon bodies of a multi-part vehicle or between two movably connected portions of a passenger bridge or passenger stairs, the bellows comprising:
a roof; and
two side walls arranged opposite one another,
wherein;
at least the two side walls or the roof or a connecting region between one of the two side walls and the roof each have a plurality of folds or corrugations;
the plurality of folds or corrugations comprises at least a first blank and a second blank connected to the first blank made of a flexible sheet material;
the first blank and the second blank are at least partially materially bonded to one another;
the first blank and the second blank overlap or abut one another along one of their sides;
an adhesive is disposed between the first blank and the second blank; and
the adhesive comprises an at least partially viscous substance and/or an adhesive tape with an elastomer.

2. The bellows according to claim 1, wherein the first and the second materially bonded blanks are not positively connected to one another.

3. The bellows according to claim 1, wherein the flexible sheet material comprises a polymer.

4. The bellows according to claim 3, wherein the polymer is an elastomer.

5. The bellows according to claim 3, wherein the polymer is selected from a group consisting of an ethylene-propylene-diene rubber, a silicone rubber, a chlorosulfonated polyethylene, a chloroprene rubber and an ethylene-vinyl acetate copolymer, or a combination thereof.

6. The bellows according to claim 3, wherein the adhesive is selected from a group consisting of an elastomer adhesive, a silicone rubber, an acrylate adhesive, a polyurethane adhesive, a resin adhesive, a dispersion adhesive and a polyvinyl acetate adhesive, or a combination thereof.

7. The bellows according to claim 1, wherein the adhesive tape has a thickness of at least 0.1 mm, of at least 0.3 mm, or of at least 0.5 mm.

8. The bellows according to claim 3, wherein a base of the polymer of the first and second blanks and a polymer of the adhesive are similar to one another, preferably identical.

9. The bellows according to claim 1, wherein one or more corrugations or folds of the bellows are formed only from the single first blank and the single second blank.

10. The bellows according to claim 1, wherein essentially two U-shaped bellows parts comprising the side walls, roof and base are connected by the first blank and the second blank.

11. The bellows according to claim 1, wherein the bellows is provided by a method comprising the following steps:
A) providing the first blank;
B) providing the second blank;
C) applying the adhesive tape with a non-vulcanized elastomer or the at least partially viscous substance to the first blank;
D) applying the second blank to the adhesive tape or the at least partially viscous substance in a manner that the first and the second blank overlap or abut one another along one of their sides; and
E) vulcanizing at least the adhesive tape or the at least partially viscous substance.

12. The bellows according to claim 11, wherein step E further includes vulcanizing the first blank or the second blank.

13. A gangway for a transitional bridge between two movably connected wagon bodies of a multi-part vehicle or between two movably connected portions of a passenger bridge or passenger stairs, comprising a bellows according to claim 1.

14. A multi-part vehicle with a transitional bridge between two movably connected wagon bodies of a multi-part vehicle comprising a bellows according to claim 1.
